(19) United States
(12) Patent Application Publication
(10) Pub. No.: US 2004/0033190 A1
(43) Pub. Date: Feb. 19, 2004

(54) Method for generating chlorine dioxide

(76) Inventors: Herve Suty, Champigny-Sur-Marne (FR); Pierre Mekarbane, Caluire Et Cuire (FR)

Correspondence Address: SMITH, GAMBRELL & RUSSELL, LLP, 1850 M STREET, N.W., SUITE 800, WASHINGTON, DC, 20036, US

(21) Appl. No.: 10/432,993

(22) PCT Filed: Oct. 22, 2001
(86) PCT No.: PCT/FR01/03271

(30) Foreign Application Priority Data
Dec. 4, 2000 (FR) 00/15678

(51) Int. Cl. C01B 11/02

(52) U.S. Cl. 423/477

(57) ABSTRACT

The invention concerns a method for generating chlorine by reacting a chlorite with an acid, which consists in using a C₁-C₁₂ alkanesulphonic acid and, more particularly, methane-sulphonic acid.

The invention relates to chlorine dioxide and the subject thereof is, more particularly, its preparation from chlorites for its use in all disinfecting, cleaning and pollutant-oxidizing applications.

On account of its oxidizing and biocidal properties, chlorine dioxide is widely used for treating drinking water, cooling-circuit water and the waters from materials in contact with foodstuffs. It is also used for processing by washing gaseous effluents (removal of odors and VOCs), for disinfecting plants for storing and transporting drinking water, and for removing pollutants (colorants, sulfides, mercaptans, etc.) in industrial waters or, in the petroleum industry, for desulfurization.

Given that chlorine dioxide is a toxic gas which is difficult to handle, cannot be stored at high concentration and is explosive when mixed with air, it is generally prepared at the time of its use as a dilute solution.

Among the various methods known for generating chlorine dioxide, the one most commonly used consists in reacting an acid with a chlorite, in particular sodium chlorite.

The acid usually used is hydrochloric acid since it gives a very high yield of chlorine dioxide. Specifically, for an HCl/NaClO₂ molar ratio of 2.2, the yield of chlorine dioxide according to the reaction:

5NaClO₂+4HCl→4ClO₂+5NaCl+2H₂O (1) exceeds 90%.

Unfortunately, as indicated by the above reaction equation, hydrochloric acid produces a considerable amount of chlorides which cause corrosion of the plants (cooling circuits, pipes, exchangers, etc.).

Other acids have been used to generate chlorine dioxide from chlorites (patents U.S. Pat. No. 4,084,747, EP 287 074, EP 423 816, U.S. Pat. No. 5,407,656 and WO 89/10747). As such, mention may be made of sulfamic acid and organic acids such as citric acid, lactic acid and salicylic acid. However, with these acids, the yield of chlorine dioxide is low and does not reach 50% for an acid/NaClO₂ molar ratio of 2.2. Furthermore, sulfamic acid is sparingly soluble in water.

It has now been found that hydrochloric acid may advantageously be replaced with methanesulfonic acid (MSA). Specifically, as shown by the comparison of equation (1) and the following equation:

5NaClO₂+4CH₃SO₃H→4ClO₂+4CH₃SO₃Na+NaCl+2H₂O (2)

MSA allows a considerable reduction in the amount of chlorides present in the chlorine dioxide solution when compared with hydrochloric acid.

Moreover, MSA, which, like hydrochloric acid, is a strong acid (pKa=−1.92), gives a chlorine dioxide yield which is comparable to that obtained with hydrochloric acid and very much superior to the yields obtained with the acids already proposed as replacements for hydrochloric acid. There is therefore no need to use a high MSA/sodium chlorite molar ratio; this results in an economy of reagent and a reduced content of residual acid in the chlorine dioxide solution prepared.

The use of MSA also has other advantages, in particular the following:

1. MSA may replace hydrochloric acid directly without changing the generator. Specifically, MSA is available as an aqueous 70% solution and is easier to handle (nonvolatile, odorless and stable).

2. MSA is readily biodegradable (100% in 28 days), nonviscous and does not evaporate.

3. In French law, MSA is approved for cleaning material in contact with foodstuffs.

4. Unlike chlorite and hydrochloric acid, there is no possible confusion between MSA and sodium chlorite since the names of the products are very different. This is important from a safety aspect.

A subject of the invention is thus a method for generating chlorine dioxide by reacting a chlorite with an acid, characterized in that the acid used is a linear or branched alkanesulfonic acid containing from 1 to 12 carbon atoms, or a mixture of such acids.

Along with MSA, which is most particularly preferred, nonlimiting examples of alkanesulfonic acids which may be mentioned are ethanesulfonic acid, propanesulfonic acid, butanesulfonic acid and octanesulfonic acid.

The chlorite used to generate the chlorine dioxide is preferably sodium chlorite, but it would not constitute a departure from the context of the present invention to use any chlorite, provided that the chlorite counterion is not an activator of the decomposition of chlorine dioxide. Non-limiting examples of such chlorites which may be mentioned are ammonium chlorite, potassium chlorite and calcium chlorite.

As in the known methods, the reaction generating chlorine dioxide is generally carried out in aqueous medium at chlorine dioxide concentrations of from 0.001% to 10% and preferably between 0.1% and 3%.

The acid/chlorite molar ratio can range from 0.1 to 50 but is preferably between 1 and 10.

The reaction temperature and pressure are not critical parameters and may vary within wide ranges. The temperature is generally between 3° C. and 120° C. and preferably between 15° C. and 40° C. The pressure can range from 1 bar to 20 bar, but the method is preferably performed at atmospheric pressure or at a pressure which may be up to 7 bar.

Depending on the value of the other parameters, the reaction time may range from 1 minute to 8 hours. It is preferably between 10 and 50 minutes.

Although the invention is directed towards completely replacing hydrochloric acid, it would not constitute a departure from the context of the present invention to use a mixture of alkanesulfonic acid with up to 10% hydrochloric acid or another acid.

In the examples which follow, which illustrate the invention without limiting it, the chlorine dioxide was assayed by UV at 360 nm on a Perkin Elmer double-beam spectrophotometer and the chlorides were assayed by ion chromatography.

### EXAMPLE 1

Aqueous sodium chlorite solution at a concentration of 115 g/l and an aqueous MSA solution at a concentration of 264 g/l were introduced simultaneously and continuously into a reactor with a contact time of 31 minutes, the flow rate of each solution being 85 ml/h, which corresponds to an MSA/NaClO₂ molar ratio of 2.2.

At the reactor outlet, the mixture was diluted with moderately mineralized mains water (pH 7.7) at a flow rate of 10 l/h.

Taking the dilution into account, the amount of NaClO₂ used was 962 mg/l and, based on equation (2), would be expected to give a theoretical production of ClO₂ equal to 573 mg/l.

Since the ClO₂ concentration of the solution obtained after dilution with mains water was 495 mg/l, the yield of the generator was 86%.

### EXAMPLE 2

Example 1 was repeated, but replacing the aqueous MSA solution at a concentration of 264 g/l with an aqueous HCl solution at a concentration of 102 g/l or with an aqueous MSA solution at a concentration of 537 g/l.

With a contact time in the reactor of 15 minutes and a flow rate of 174 ml/h of each reagent, a total flow rate of 19.46 l/h was obtained after dilution with mains water.

The results of these tests are summarized in the table below.

| Acid used | HCl | | MSA | |
|---|---|---|---|---|
| [acid] | 102 | g/l | 537 | g/l |
| Acid/NaClO₂ molar ratio | 2.2 | | 4.4 | |
| Theoretical [ClO₂] | 613 | mg/l | 613 | mg/l |
| [ClO₂] analysed | 582 | mg/l | 576 | mg/l |
| Yield of the generator | 95% | | 94% | |
| Residual [Cl⁻] | 2.1 | g/l | 0.22 | g/l |

Since the mains water used to dilute the solution leaving the generator had an average chloride ion content of 25 mg/l, the chlorides present are mainly due to the reaction: acid+chlorite ions. On examining the above results, it is found that, for an identical generator yield, the amount of residual chlorides is about 10 times greater via the HCl route than via the MSA route.

In order to evaluate the stability of the chlorine dioxide generated by the MSA and HCl routes, the ClO₂ solutions generated in this example were stored in transparent glass bottles and placed in daylight. The ClO₂ concentration was monitored for 15 days in order to evaluate the decomposition of the solution.

| | HCl route | MSA route |
|---|---|---|
| Initial [ClO₂] | 582 mg/l | 576 mg/l |
| 5 days | −26% | −20% |
| 10 days | −48% | −45% |
| 15 days | −59% | −56% |

It emerges from the results in the above table that the ClO₂ generated via the MSA route and at least as stable as that generated via the HCl route.

### EXAMPLE 3

The method was performed as in Examples 1 and 2 with different acids and under the following conditions:

| [NaClO₂] | 115 | g/l |
|---|---|---|
| [acid] | see table | |
| flow rate of each reagent | 152 | ml/h |
| contact time in the reactor | 18 | minutes |
| total flow rate | 19.89 | l/h |
| theoretical [ClO₂] | 525 | mg/l |

Except in the case of sulfamic acid, whose solubility limit controls the concentration of the acid solution, the acid concentration of the other solutions was chosen so as to have an acid/NaClO₂ molar ratio equal to 2.2.

The table below collates the results of these tests.

| | [acid] in | | |
|---|---|---|---|
| Acid used | g/l | [ClO₂] analysed | Yield (%) |
| HCl | 102 | 490 | 93 |
| MSA | 264 | 390 | 74 |
| Citric acid | 577 | 231 | 44 |
| Lactic acid | 250 | 153 | 29 |
| Sulfamic acid | 147 | 84 | 16 |

### EXAMPLE 4

Example 1 was repeated, but varying the flow rate of the reagents and thus the residence time in the reactor.

The results collated in the table below show that the optimum reaction time for the MSA+sodium chlorite mixture is between 25 and 35 minutes, the maximum yield being about 85%.

| Flow rate of | | | [ClO₂] | |
|---|---|---|---|---|
| each reagent | Total flow | Reaction | analysed | Yield of |
| (ml/h) | rate (l/h) | time (min) | (mg/l) | generator |
| 164 | 18.4 | 16.5 | 399 | 66% |
| 139 | 18.0 | 19.5 | 394 | 75% |
| 114 | 18.0 | 23.7 | 346 | 80% |
| 86 | 10.2 | 31.4 | 495 | 86% |
| 62 | 10.1 | 43.5 | 297 | 71% |

### EXAMPLE 5

Biocidal tests on highly polluted water were carried out using residual water (ERU) taken at the outlet of the Colombes purification plant (pH=7.5-8). The chemical demand of ClO₂ for this water was 1.7 mg/l (concentration limit from which a residual ClO₂ begins to be observed after a contact time of 15 minutes).

In a first series of tests, the bacterial counting was carried out using Bacti-Count T samplers which are representative of the total microorganisms and allow counting of between 10³ and 10⁷ bacteria per millilitre. A blank was carried out beforehand to determine the concentration of bacteria in the water leaving the purification plant.

Two treatments using 1 mg/l of ClO₂, generated via the HCl route and via the MSA route, were then carried out on this water. Once the biocidal agent is injected, the sample is left in the dark for 15 minutes and the Bacti-Count lozenges are then dipped in the sample. They are drained and incubated at about 30° C.

The results collated in the table below show that, in both cases, the inactivation of the total microorganisms is greater than 99% (equivalent to an inactivation of 1 log). These biocidal tests do not show any difference between the inactivation of the total microorganisms with chlorine dioxide via the HCl route and the MSA route.

| Solution | Bacteria/ml |
|---|---|
| Water leaving the station | 10⁵ to 10⁶ |
| 1 mg/l of ClO₂ via HCl route | <10³ |
| 1 mg/l of ClO₂ via MSA route | <10³ |

A second series of biocidal tests was carried out on Petrifilm 3M (total flora); these are square-ruled strips containing agar on the upper film. The samples are now treated with 0.2, 0.4 and 0.8 mg/l of ClO₂. The operations are identical to those of the previous tests (Bacti-Count), except that several dilutions are prepared.

| | % elimination | % elimination |
|---|---|---|
| [ClO₂] | via HCl route | via MSA route |
| 0.2 mg/l | 21.5 | 39.0 |
| 0.4 mg/l | 85.0 | 68.5 |
| 0.8 mg/l | 98.5 | 87.5 |

From the results collated in the above table, it may be concluded that the biocidal efficacy of chlorine dioxide is identical (within a 10% margin) by whatever method it is generated: MSA or HCl.

### EXAMPLE 6

The inactivation of Escherichia Coli bacteria (1.5−5×10⁸ CFU/ml) was tested (5 minutes at 25° C.) according to standard NF EN 1276. According to this standard, a product is said to be active if the inactivation (R) is greater than or equal to 5 log.

The examination of the results of these tests (see table below) shows that the biocidal activity is identical, whether the chlorine dioxide is produced from HCl or from MSA.

| | | Inactivation via | Inactivation via |
|---|---|---|---|
| [ClO₂] | | HCl route (log) | MSA route (log) |
| 3 | mg/l | 2 | 2 |
| 3.5 | mg/l | 4.9 | 4.9 |
| 4 | mg/l | 6.8 | 6.4 |

### EXAMPLE 7

Chlorine dioxide solutions were prepared in situ by directly mixing aqueous solutions of MSA and of sodium chlorite.

With an MSA/NaClO₂ molar ratio set at 3, the formation of appreciable amounts of chlorine dioxide is observed.

| | [NaClO₂] = 34 mg/l | [NaClO₂] = 134 mg/l |
|---|---|---|
| Reaction | [MSA] = 107 mg/l | [MSA] = 429 mg/l |
| time | [ClO₂] mg/l | [ClO₂] mg/l |
| 30 min. | 5.1 | 5.9 |
| 60 min. | 6.5 | 8.1 |

### EXAMPLE 8

Tests were performed with the aim of studying the static corrosiveness by weight loss due to the acidic solutions on various metals. Since the production of chlorine dioxide depends on the acid/ chlorite molar ratio, it is appropriate in this case to calculate in terms of number of moles of acid rather than in terms of weight of commercial product.

8.1 MSA Compared with HCl

The tests were performed with 33-cm² nonalloyed aluminum plates (family 10 000, A5, purity>99.5%).

Before the test, the plates were subjected to the following treatments:

stripping in a 50 g/l sodium hydroxide solution maintained at 50° C.,

rinsing with demineralized water,

neutralizing at 25° C. in 50% nitric acid solution,

drying and immediate weighing.

The plates were then immersed for 24 hours, at 60° C. and with stirring using a magnetic bar, in one litre of a solution containing 0.103 mol/l of acid in demineralized water, this solution being placed in a reactor on which is fitted a condenser.

After the test, the plates were subjected to the following treatments:

stripping of the corrosion layer at 80° C. in a solution of chromic oxide (20 g) and 85% orthophosphoric acid (50 ml) in one litre of demineralized water,

rinsing and scrubbing with a Nylon brush,

rinsing again, drying and weighing.

The table below shows the weight loss (Δm) observed and the corresponding rate of corrosion (V).

Aluminum

| Acid/metal | Δm (g) | V corr (mm/year) |
|---|---|---|
| MSA | 0.0955 | 3.87 |
| HCl | 0.4230 | 17.16 |

From these results, it may be concluded that MSA is much less corrosive than hydrochloric acid on aluminum.

8.2 MSA Compared with Sulfamic Acid

The tests were carried out with 12-cm² AG5 aluminum plates (moulded alloy, 5% Mg, family 50,000) or with XC18 carbon steel plates, and using a water from Contrexéville (typical composition: SO₄²⁻=1.192 g/l; Ca²⁺=0.476 g/l; Mg²⁺=0.084 g/l; HCO₃₋=0.377 g/l; Cl⁻=0.007 g/l; Na⁺=0.007 g/l; K⁺=0.003 g/l).

The plates were immersed, for 144 hours at 40° C. in a closed reactor, in 100 ml of an aqueous acid solution at a concentration of 0.103 mol/l.

Before and after the test, the aluminum plates were treated as described in 8.1.

Before the test, the XC18 steel plates were treated in the following way:

degreasing with trichloroethylene,

polishing with 400 and 600 paper,

rinsing and drying with compressed air.

After the test, the XC18 steel plates were immersed in a 10% HCl solution supplemented with a few drops of corrosion inhibitor (Norust CM 150 from the company CECA) and then rubbed with a rubber tip to remove the rust, rinsed with water and dried with compressed air.

The examination of the results collated in the table below shows that MSA shows advantages over sulfamic acid as regards the corrosion on carbon steel and aluminum.

| | XC18 steel | | Aluminum | |
|---|---|---|---|---|
| | | V corr | | V corr |
| Acid/metal | Δm (g) | (mm/year) | Δm (g) | (mm/year) |
| MSA | 0.2894 | 1.87 | 0.1151 | 1.62 |
| Sulfamic acid | 0.5836 | 3.77 | 0.2488 | 3.50 |

1. A method for generating chlorine dioxide by reacting a chlorite with an acid, characterized in that the acid used is a linear or branched alkanesulfonic acid containing from 1 to 12 carbon atoms, or a mixture of such acids.

2. The method as claimed in claim 1, in which methanesulfonic acid is used.

3. The method as claimed in claim 1 or 2, in which sodium chlorite is used.

4. The method as claimed in one of claims 1 to 3, in which the acid/chlorite molar ratio ranges from 0.1 to 50 and is preferably between 1 and 10.

5. The method as claimed in one of claims 1 to 4, in which the reaction is carried out at a temperature of between 3° C. and 120° C. and preferably between 15° C. and 40° C.

6. The method as claimed in one of claims 1 to 5, which is performed at a pressure ranging from 1 to 20 bar and preferably 1 to 7 bar.

7. The method as claimed in one of claims 1 to 6, in which the reaction time ranges from 1 minute to 8 hours and is preferably between 10 and 50 minutes.
